(19) United States
(12) Patent Application Publication
(10) Pub. No.: US 2023/0182298 A1
(43) Pub. Date: Jun. 15, 2023

(54) PLACEMENT PLANNING

(71) Applicant: Intrinsic Innovation LLC, Mountain View, CA (US)

(72) Inventors: Abhishek Sriraman, Mountain View, CA (US); Saurabh Nair, Mountain View, CA (US); Bhaskara Mannar Marthi, Sunnyvale, CA (US)

(21) Appl. No.: 18/080,669

(22) Filed: Dec. 13, 2022

Related U.S. Application Data
(60) Provisional application No. 63/288,756, filed on Dec. 13, 2021.

(51) Int. Cl. B25J 9/16

(52) U.S. Cl. CPC B25J 9/1664; B25J 9/1612

(57) ABSTRACT

Methods, systems, and apparatus, including computer programs encoded on computer storage media, for performing planning for robotic placement tasks. One of the methods includes receiving a request for a robot to perform a placement task with an object, wherein the placement task has an associated insertion plane, wherein the request specifies a location on the insertion plane and an orientation angle for the object. A plan is generated for the robot including generating a rotational motion to transition the gripped object from an initial orientation to an orientation in which a principal vector is aligned with the insertion plane and the object is aligned with the orientation angle of the request.

### CROSS-REFERENCE TO RELATED APPLICATION

This application claims the benefit under 35 U.S.C. § 119(e) of the filing date of U.S. Provisional Patent Application No. 63/288,756, filed on Dec. 13, 2021, entitled “System and Method for Insertion Planning,” the entirety of which is herein incorporated by reference.

### BACKGROUND

This specification relates to robotics, and more particularly to planning robotic movements.

Robotics planning refers to scheduling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators.

Robotics planning has traditionally required immense amounts of manual programming in order to meticulously dictate how the robotic components should move in order to accomplish a particular task. Manual programming is tedious, time-consuming, and error prone.

Placement planning is one such robotic planning task that has traditionally required tedious and time consuming manual programming. In this context, placement planning refers to planning the movements of a robotic manipulator, e.g., a robotic arm, to move an object into a particular volume of space, e.g., into a container. The complexity of placement planning stems from the fact that there exist a number of similar desired object placements that can be appropriate for an application. In addition, an over-specified constraint may unnecessarily limit the set of feasible solutions. Moreover, planning for an over-specified constraint may be more susceptible to representation errors, e.g., errors in the estimated pose of the gripped object.

### SUMMARY

This specification describes how a system can perform placement planning using only three inputs: an x and y location on an insertion plane, as well as an object angle for an object. This arrangement greatly simplifies the task of placement planning for users, and which can be extended to other kinds of similar tasks.

Particular embodiments of the subject matter described in this specification can be implemented so as to realize one or more of the following advantages. Using the placement task planning techniques described in this specification speeds up the task of specifying parameters for placement planning. In addition, by constraining the search space as described below, the system can converge on a solution much faster than when performing full 6DOF planning. These techniques can also be applied to many other kinds of robotic manipulation tasks. In addition, the techniques described in this specification are less prone to representation errors because the full 6DOF object pose of an object or a container need not be specified to find a solution. Moreover, the techniques described in this specification can be particularly useful for planning placement asks for objects that have a poorly formed or only partially formed 6DOF pose, which is often the case for deformable objects. Therefore, providing a way to perform robust placement task planning for such objects improves the capabilities and reliability of the system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system.

FIG. 2 illustrates an example of a relative orientation between an insertion plane normal and a control axis of an end effector.

FIG. 3 is a flowchart of an example process for generating a placement task motion plan.

FIG. 4 illustrates an example of computing a rotation for an object.

Like reference numbers and designations in the various drawings indicate like elements.

### DETAILED DESCRIPTION

This specification describes how a system can automatically derive constraints for placement task planning in a way that simplifies the inputs that are required. In particular, in some implementations a user can cause a robot to perform a fully specified placement task by providing just three input values.

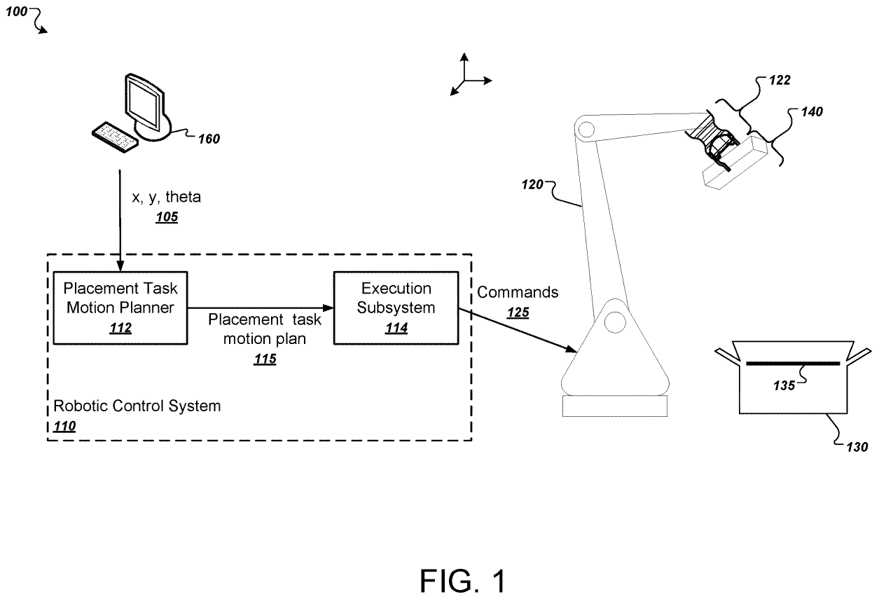

FIG. 1 is a diagram that illustrates an example system 100. The system 100 is an example of a system that can implement the placement task planning techniques described in this specification.

The system includes a user device 160, a robotic control system 110, and a robot 120 that is operable to manipulate objects in a working environment, e.g., a robotic workcell. In this example, the robot 120 is illustrated as placing an object 140 into a container 130. The robot 120 has an end effector 122, which in this example is a gripper holding the object 140. However, the same techniques described in this specification can be used with any appropriate kind of end effector, such as vacuum or suction end effectors, or specialized end effectors configured to pick up objects.

The robotic control system 110 provides commands 125 to be executed by the robot 120. In order to compute the commands 125, the robotic control system 110 can consume status messages generated by the robot 120 as well as sensor observations made by one or more sensors in the working environment.

The robotic control system 110 includes a number of functional components, including placement task motion planner 112 and an execution subsystem 114. Each of these components can be implemented as computer programs installed on one or more computers in one or more locations that are coupled to each other through any appropriate communications network, e.g., an intranet or the Internet, or combination of networks.

The placement task motion planner 112 can generate a placement task motion plan 115 that fully specifies how the robot 120 should move an object into the container 130. The placement task motion plan 115 is then consumed by the execution subsystem 114, which drives the robot 120 to perform the placement task.

The placement task motion planner 112 and the execution subsystem 114 can operate according to different timing constraints. For example, the execution subsystem 114 can be a real-time control system with hard real-time requirements. Real-time software control systems are software systems that are required to execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation. The placement task motion planner 112, on the other hand, typically has more flexibility in operation. The placement task motion planner 112 might generate a placement task motion plan 115 only periodically, or after each next object is gripped by the robot, or only upon receiving input from the user device 160.

The user device 160 can be any appropriate computing device for using or controlling the robotic control system 110. As described above, the placement task motion planner 112 can generate a fully specified motion plan from a location on an insertion plane and an orientation angle. Thus, the user device 160 can provide x, y, and theta values 105 to the placement task motion planner 112. The x and y values specify the location on the insertion plane, and the theta value can specify a target rotation of the object within the insertion plane.

A user can use the user device 160 to specify these values in any appropriate way, for example, programmatically, on the command line, or through a graphical user interface, to name just a few examples.

In a typical robotics control system, each of the container 130, the object 140, and the end effector 122 would require fully specified 6 degree-of-freedom (6DOF) values. Each set of 6DOF values includes three values for a location (e.g., x, y, and z), and three values for an orientation (e.g., roll, pitch, and yaw) for each of three rotational axes.

In order to simplify the process of specifying a placement task, the placement task motion planner 112 can automatically apply a variety of constraints and heuristics.

First, the placement task can operate relative to an insertion plane, which is a plane in three-dimensional space in the working environment. In some implementations, the placement task motion planner 112 can generate a motion plan that aligns a principal vector of the object with the insertion plane. For example, a principal vector of a pencil can run along the length of the pencil, and aligning the principal vector of the pencil with the insertion plane can involve laying the pencil flat against the insertion plane. The principal vector of an object can be defined by a user or by a digital model of the object. Alternatively or in addition, the system can automatically determine the principal vector of an object according to a vector that has the longest length through the object.

For the task of placing objects into a container, the insertion plane can be defined as a plane that covers the top opening of the container. In this example, the container 130 has an insertion plane 135 that is aligned with the top opening of the container. However, the insertion plane need not be horizontal to the floor of the working environment and can instead assume any appropriate orientation.

In addition, in this specification, a placement task need not require placing or inserting an object into a container. Rather, a placement task can be any robotic task that involves aligning a controllable frame of the robot with an insertion plane. For example, an insertion plane can be defined as a subset of the field of view of a sensor in the working environment, which can be an example of an insertion plane having a vertical orientation.

The placement task motion planner 112 can then assume a predefined relative orientation between an insertion plane normal and a control axis of the end effector. The insertion plane normal can be defined as a vector at right angles to the insertion plane in a particular direction.

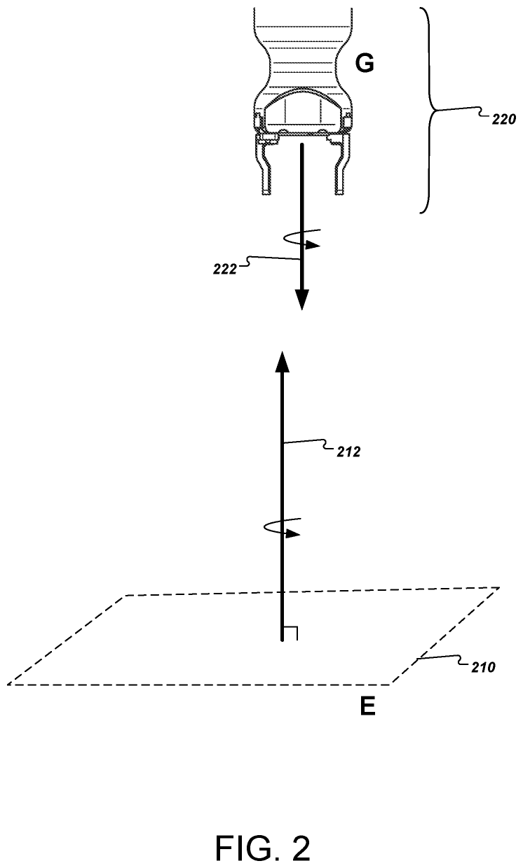

FIG. 2 illustrates an example of a relative orientation between an insertion plane normal 212 and a control axis 222 of an end effector 220. In FIG. 2, an insertion plane E 210 has an insertion plane normal 212. A gripper G 220 has a control axis 222. In this example, the control axis 222 represents how the gripper can rotate around the z axis.

One example of a predefined relative orientation is that the insertion plane normal 212 and the control axis 222 must be aligned or aligned within a threshold distance or angle. In the example of FIG. 2, the control axis 222 and the insertion plane normal 212 are not precisely aligned, but for the particular placement task being performed, the illustrated alignment may satisfy a threshold distance to be considered aligned. In this context, being a predefined relative orientation means that the constraint between the insertion plane normal 212 and the control axis 222 is defined before the request to initiate the placement task is received by the placement task motion planner. When the alignment constraint illustrated in FIG. 2 is enforced, it means that the robot will perform the placement action in only a substantially top-down fashion. However, the predefined relative orientation can also be specified so that the end effector approaches the insertion plane at a particular angle rather than top-down.

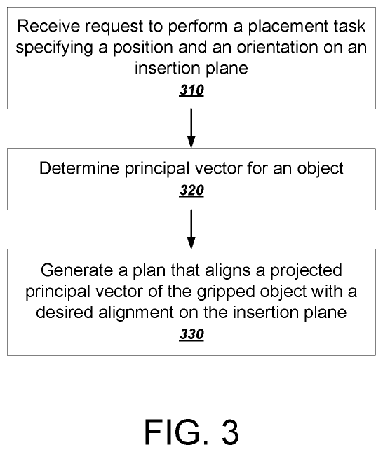

FIG. 3 is a flowchart of an example process for generating a placement task motion plan. The example process can be performed by a system of one or more computers in one or more locations and programmed in accordance with this specification. The example process will be described as being performed by a system of one or more computers, e.g., the placement task motion planner 112 of FIG. 1.

The system receives a request for a robot to perform a placement task specifying a position and an orientation on an insertion plane (310). As described above, the placement task has an associated insertion plane, and the request can specify a position on the insertion plane and a target orientation for the object on the insertion plane. The target orientation can be specified as the value of an angle of a particular rotational axis of the object.

The system determines a principal vector for the object (320). In some implementations, the principal vector is predefined by a user. Alternatively or in addition, the system can maintain a library of principal vectors for each of one or more different types of objects. Alternatively or in addition, the system can compute the principal vector according to a vector that has a longest length through the object.

The system generates a plan that aligns a projected principal vector of the gripped object with a desired alignment on the insertion plane (330). The plan, when executed, will typically include a translational motion and a rotational motion and will cause the robot to move the object so that it is aligned with, e.g., above, the specified location in the insertion plane. The plan will thus align a control axis of the end effector with a normal of the insertion plane. The plan can also include moving the object toward the insertion plane until passing through the insertion plane or otherwise making contact with the insertion plane. The rotational motion will cause the robot to rotate the gripped object so that it aligns with the target orientation. In order to compute the rotational motion, the system can project the gripped pose of the object and the desired pose of the object onto the insertion plane and then compute an angle between the principal vectors of the projection. The computed angle is the angle of rotation within the insertion plan that is needed to align the gripped object with the target object pose.

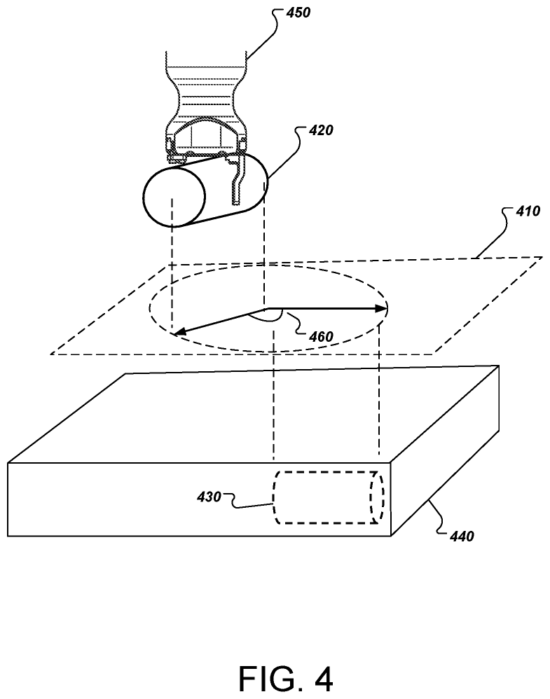

FIG. 4 illustrates an example of computing a rotation for an object. In FIG. 4, an insertion plane 410 is above a container 440. A target orientation 430 of the object is specified within the container. A current orientation of the object 420 represents how the object is oriented as it is gripped by an end effector 450.

The system can project the principal vectors for both the current orientation of the object 420 and the target orientation of the object 430 onto the insertion plane 410.

The system can then compute an angle 460 between the projections of the principal vectors on the insertion plane 410 in order to determine how to rotate the object so that the object is aligned with the target orientation 430 when the object is lowered into the container 440.

The techniques described above can be extended to any appropriate planning task in which a 6D robot is to be commanded with a 3D parameterization, e.g., x, y, and theta. For example, these techniques can be used to more easily command a robot to grasp an object from a grasping plane. As another example, these techniques can be used to more easily command a robot to show an object to a sensor, e.g., a camera, in an image plane.

In this specification, a robot is a machine having a base position, one or more movable components, and a kinematic model that can be used to map desired positions, poses, or both in one coordinate system, e.g., Cartesian coordinates, into commands for physically moving the one or more movable components to the desired positions or poses. In this specification, a tool is a device that is part of and is attached at the end of the kinematic chain of the one or more moveable components of the robot. Example tools include grippers, welding devices, and sanding devices.

In this specification, a task is an operation to be performed by a tool. For brevity, when a robot has only one tool, a task can be described as an operation to be performed by the robot as a whole. Example tasks include welding, glue dispensing, part positioning, and surfacing sanding, to name just a few examples. Tasks are generally associated with a type that indicates the tool required to perform the task, as well as a position within a workcell at which the task will be performed.

In this specification, a motion plan is a data structure that provides information for executing an action, which can be a task, a cluster of tasks, or a transition. Motion plans can be fully constrained, meaning that all values for all controllable degrees of freedom for the robot are represented explicitly or implicitly; or underconstrained, meaning that some values for controllable degrees of freedom are unspecified. In some implementations, in order to actually perform an action corresponding to a motion plan, the motion plan must be fully constrained to include all necessary values for all controllable degrees of freedom for the robot. Thus, at some points in the planning processes described in this specification, some motion plans may be underconstrained, but by the time the motion plan is actually executed on a robot, the motion plan can be fully constrained. In some implementations, motion plans represent edges in a task graph between two configuration states for a single robot. Thus, generally there is one task graph per robot.

In this specification, a motion swept volume is a region of the space that is occupied by a least a portion of a robot or tool during the entire execution of a motion plan. The motion swept volume can be generated by collision geometry associated with the robot-tool system.

In this specification, a transition is a motion plan that describes a movement to be performed between a start point and an end point. The start point and end point can be represented by poses, locations in a coordinate system, or tasks to be performed. Transitions can be underconstrained by lacking one or more values of one or more respective controllable degrees of freedom (DOF) for a robot. Some transitions represent free motions. In this specification, a free motion is a transition in which none of the degrees of freedom are constrained. For example, a robot motion that simply moves from pose A to pose B without any restriction on how to move between these two poses is a free motion. During the planning process, the DOF variables for a free motion are eventually assigned values, and path planners can use any appropriate values for the motion that do not conflict with the physical constraints of the workcell.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers, the method comprising:
receiving a request for a robot to perform a placement task with an object, wherein the placement task has an associated insertion plane,
wherein the request specifies a location on the insertion plane and an orientation for the object on the insertion plane;
determining a principal vector of the object; and
generating a plan for the robot including generating a motion that aligns the projected principal vector of the object with a target alignment on the insertion plane.

2. The method of claim 1, wherein generating the plan comprises:
projecting a first principal vector of a gripped object pose of the object onto the insertion plane;
projecting a second principal vector of a target object pose of the object onto the insertion plane; and
determining an angle of rotation to align the first principal vector projected from the gripped object pose to the second principal vector projected from the target object pose.

3. The method of claim 1, wherein generating the plan comprises generating a translational motion to transition the object from an initial location to a location that is aligned with the location on the insertion plane.

4. The method of claim 3, wherein generating the translational motion comprises generation a translational motion that aligns a control axis of an end-effector of the robot with the insertion plane normal.

5. The method of claim 4, wherein generating the plan comprises generating an insertion motion that is aligned with the insertion plane normal.

6. The method of claim 1, further comprising:
executing the plan to cause the robot to move the object in a direction aligned with the insertion plane normal.

7. The method of claim 1, wherein determining the principal vector for the object comprises determining a vector having the longest length through the object.

8. The method of claim 1, wherein the request specifies only three values: two coordinates for the location on the insertion plane, and an angle value for the orientation of the object.

9. The method of claim 1, wherein the insertion plane overlaps a field of view of a sensor and wherein the plan, when executed by the robot, causes the robot to move the object to within the field of view of the sensor.

10. The method of claim 1, wherein the insertion plane overlaps an opening of a container and wherein the plan, when executed by the robot, causes the robot to place the object within the container according to the orientation angle.

11. A system comprising:
one or more computers and one or more storage devices storing instructions that are operable, when executed by the one or more computers, to cause the one or more computers to perform operations comprising:
receiving a request for a robot to perform a placement task with an object, wherein the placement task has an associated insertion plane,
wherein the request specifies a location on the insertion plane and an orientation for the object on the insertion plane;
determining a principal vector of the object; and
generating a plan for the robot including generating a motion that aligns the projected principal vector of the object with a target alignment on the insertion plane.

12. The system of claim 11, wherein generating the plan comprises:
projecting a first principal vector of a gripped object pose of the object onto the insertion plane;
projecting a second principal vector of a target object pose of the object onto the insertion plane; and
determining an angle of rotation to align the first principal vector projected from the gripped object pose to the second principal vector projected from the target object pose.

13. The system of claim 11, wherein generating the plan comprises generating a translational motion to transition the object from an initial location to a location that is aligned with the location on the insertion plane.

14. The system of claim 13, wherein generating the translational motion comprises generation a translational motion that aligns a control axis of an end-effector of the robot with the insertion plane normal.

15. The system of claim 14, wherein generating the plan comprises generating an insertion motion that is aligned with the insertion plane normal.

16. The system of claim 11, wherein the operations further comprise:
executing the plan to cause the robot to move the object in a direction aligned with the insertion plane normal.

17. The system of claim 11, wherein determining the principal vector for the object comprises determining a vector having the longest length through the object.

18. The system of claim 11, wherein the request specifies only three values: two coordinates for the location on the insertion plane, and an angle value for the orientation of the object.

19. The system of claim 11, wherein the insertion plane overlaps a field of view of a sensor and wherein the plan, when executed by the robot, causes the robot to move the object to within the field of view of the sensor.

20. One or more non-transitory computer storage media encoded with computer program instructions that when executed by one or more computers cause the one or more computers to perform operations comprising:
receiving a request for a robot to perform a placement task with an object, wherein the placement task has an associated insertion plane,
wherein the request specifies a location on the insertion plane and an orientation for the object on the insertion plane;
determining a principal vector of the object; and
generating a plan for the robot including generating a motion that aligns the projected principal vector of the object with a target alignment on the insertion plane.
